(19) United States
(12) Patent Application Publication
(10) Pub. No.: US 2015/0357948 A1
(43) Pub. Date: Dec. 10, 2015

(54) Hand Worn Wireless Remote Controller For Motors

(71) Applicant: Kevin W. Goldstein, Berwyn, PA (US)

(72) Inventor: Kevin W. Goldstein, Berwyn, PA (US)

(21) Appl. No.: 14/296,609

(22) Filed: Jun. 5, 2014

(51) Int. Cl. H02P 7/08; G05D 7/06

(52) U.S. Cl. CPC H02P 7/08; G05D 7/0676

(57) ABSTRACT

A radio frequency (“RF”) remote control device for use to control the speed of a motor is disclosed. In one preferred embodiment, the device may be used by a swimmer in a swim spa. The RF device can be preferably formed in shape of a glove to be worn by the athlete/swimmer, such that he or she can readily change the speed of the swim spa current motor, and in turn the speed of the current he or she is swimming against simply by activating respective increase or decrease motor speed signals. In further embodiments, the RF device can also include a stop watch to record duration of exercise, and/or an automatic stroke counter to record the number of strokes during the exercise.

### FIELD OF THE INVENTION

The present invention relates to wireless remote control devices and systems. More particularly this invention relates to devices, systems and methods using radio frequency technology to remotely control a motor, which in turn may be used as part of exercise equipment to control the speed or exertion level of the exercise. Still more particularly, the device and system may be used to control the drive or current motor in a swim spa to control current speed. The device may be formed as a complete or partial glove to be worn by a user, and is used as part of a system including radio frequency (“RF”) circuits such that the user can activate and wirelessly send RF signals to a motor controller to increase or decrease the motor speed, or alternatively to stop the motor. As used in a swim spa setting, the device allows the user to control water current without interrupting his or her exercise and swim stroke. In the form of a glove, the user has an intuitive and easy means of precisely controlling the motor driving the speed of the swim current.

In further embodiments, the device can be augmented to include a stop watch to monitor duration of the exercise, and/or the device can include a built in stroke counter to automatically record the number of swim strokes during the exercise. A further enhanced embodiment would include a heart rate monitor position within the glove device, with such sensed data being wirelessly transmitted to a local display device. Still further embodiments of the system may include a computer processor with associated data memory such that the time history of the motor speed may be recorded and stored in the computer processor data memory, which can then be available for recall to drive the current motor and allow the user to repeat the recorded motor speed time history.

### BACKGROUND OF THE INVENTION

Motors, including electric and hydraulic motors, are used to drive or move many different items or media, include air (e.g., fans) or water (e.g., pumps or fans). The ability to precisely control the speed of the motor is often a critical aspect of proper and/or efficient use of the motor. For example, in various exercise embodiments, including treadmills or swim spas, the control of the motor speed equates to the control of the speed of the treadmill or swim current, and thus, the speed at which the exercise is accomplished and the user's or athlete's exertion level.

Various means of controlling a motor's speed, both directly and remotely have been used for decades. Several examples of such remote control devices are described herein.

A remote control system for use with a boat trolling motor is disclosed in U.S. Pat. No. 6,054,831, issued to Moore et al., specifically for a Radio Frequency Remote Control For Trolling Motors. As described in the '831 patent, the remote control is through a foot actuated switching device that can either control the motor through radio frequency signals or infrared signals. Nothing in the '831 patent teaches use of a hand worn device to control the trolling motor speed.

A casement window opening and closing mechanism is taught in U.S. patent application Ser. No. 12/798,038, by Thorne, entitled RF-Remote Control, Retrofitted Self-Contained, Automatic Window Opener For Casement Windows Or The Like. More specifically, the '038 application discloses a remote control system, including a battery powered DC electric motor to open and close casement windows using remote control through radio frequency (“RF”) signals. As with the '831 patent, there is no disclosure of any hand-worn control mechanism to actuate the motor control.

European Patent Application No. 0923060, for a Wireless Remote Control System For Electrical Devices, by Depauw, discloses a system using a plurality of RF transmitters and RF receivers to remotely control pumps, motors, heaters, and lights. The RF receivers are electrically connected to the particular device to be controlled and the RF transmitters are remote from the RF receiver or devices to be controlled. Upon activation by a user, the RF transmitter sends an RF signal to the RF receiver to turn on or turn off the device to be controlled. The '060 application does not disclose use of a hand worn control device in association with the RF transmitter.

U.S. patent application Ser. No. 13/303,090, for a Ruggedized Control Glove Allowing Dynamic Balance And Undivided Visual Attention, by Rott et al., more particularly discloses a wireless control glove for use with powered rideable boards, mobility devices, or remote-controlled (“RC”) models. As described in the '090 application, the glove may be configured with an input transducer, a transceiver, and an output transducer to permit the user to enter acceleration and steering commands. While the '090 application device does use a glove to provide wireless remote control signals for controlling powered boards, mobility devices and RC models, the device also requires a power supply and electrical circuitry that is integral as part of the glove. Also, although the glove is described as being “ruggedized,” there is no disclosure that the glove may be immersed in water or a water environment. Accordingly, even if“ruggedized,” having electricity in a water environment, or where the glove may be immersed in water, is not the safest usage. Moreover, there is no suggestion in the '090 application of any means to record and playback the control inputs from the glove.

Similarly, U.S. Pat. No. 7,109,970, for an Apparatus For Remotely Controlling Computers And Other Electronic Appliances/Devices Using A Combination Of Voice Commands And Finger Movements, by Miller, teaches a three-finger apparatus to be worn on the user's hand that comprises a plurality of touch-sensitive touchpads and/or motion sensitive elements, and a microphone, all used to operate a computer or the on-screen cursor. Although the '970 patent discloses a device to worn on a user's hand, the control mechanism is directed solely to enter commands into a computer, thereby replacing the need for an associated computer mouse. There is no suggestion or motivation to use the '970 patent apparatus to remotely control exercise equipment or electric or hydraulic motors. Moreover, the '970 patent device, similar to the '090 application device requires that electrical power be incorporated into the hand worn element. As such, like the '090 application device, including electrical power supplies within a hand worn device that is to be used in a water environment or where the device may be fully immersed in water, is simply not recommended or safe. Further, similar to the '090 application device, there is no suggestion in the '970 patent of any means to record and playback the control inputs from the hand worn device.

While certain of these devices appear to address the problem of controlling a motor through remote means, or to provide a device worn on a user's hand to control a computer or recreational equipment, none is directed to solving the problem of controlling the speed of a motor used on exercise equipment, including a treadmill or swim spa, and permitting recording and playback of a time history of the exercise equipment motor speed. As such, these problems, as well as other deficiencies are intended to be overcome and solved by the present invention.

Accordingly, it would be desirable to have a wireless remote control for a motor that is used, for example, with various exercise machines, where the remote control includes a device that is worn on the athlete's hand, including such as a glove or partial glove, and the exercise machine motor speed control is intuitively and easily controlled by finger activation or touching of various parts of the glove to either increase or decrease the motor speed, or stop the motor altogether. It would be further desirable to have incorporated with the remote control device a stop watch and/or an automatic stroke counter to count swim strokes. It would also be desirable to have a computer processor in communication with the remote control system to record a time history of the motor speed, such that the recorded and stored time history can be later recalled from the computer processor memory and used to drive the exercise equipment motor at a future time, thereby reproducing the motor speed and exercise routine for the athlete. Such improvements and results have not been seen or achieved in the relevant art.

### SUMMARY OF THE INVENTION

The above noted problems inadequately or incompletely resolved by the prior art are addressed and resolved by the present invention.

A preferred aspect of the invention is a device to remotely control a motor, using radio frequency signals, comprising an apparatus worn on a user's hand; a radio frequency transmitter incorporated into said apparatus; a radio frequency receiver within communication proximity to said radio frequency transmitter; a motor communicatively connected to said radio frequency receiver, wherein said user may remotely control the speed of said motor by activating said radio frequency transmitter incorporated into said apparatus, whereby upon activation by the user, a radio frequency signal is read from the radio frequency transmitter by said radio frequency receiver, and said signal is transmitted to said motor to control said motor speed.

A further preferred aspect of the present invention, is a system to remotely control and record the speed of a current motor used in a swim spa, using radio frequency signals, comprising an apparatus worn on a swimmer's hand; at least one radio frequency transmitter incorporated into said apparatus; a radio frequency receiver in communication with said radio frequency transmitter; a computer processor with data memory storage; a motor communicatively connected to said radio frequency receiver and to said computer processor; wherein said user may remotely control the speed of said motor by activating said at least one radio frequency transmitter incorporated into said apparatus, whereby upon activation by the user, a radio frequency signal is read by said radio frequency receiver to control said motor speed; and further wherein said motor speed control signals are recorded as a function of time by said computer processor and stored in said data memory, such that the recorded motor speed control may be used, at a later time, to control said motor speed by the recorded motor speed.

Another preferred embodiment of the present invention is a method for remotely controlling the speed of a current motor used in a swim spa, comprising the steps of (a) sensing whether an RF signal to increase or decrease motor speed is being transmitted remotely by a swimmer in said swim spa; (b) increasing said motor speed if an increase signal is received; (c) decreasing said motor speed if a decrease signal is received; (d) stopping said current motor if a stop motor signal is received; (e) recording said motor speed control signals as a function of time; (f) storing in a computer memory the recorded motor speed control signals as a function of time; and (g) thereafter being able to control the swim current motor speed by recalling said recorded and stored motor speed control signals and controlling the current motor at a later time by replaying the recorded motor speed control signals.

The invention will be best understood by reading the following detailed description of the preferred embodiments in conjunction with the drawings briefly described below.

### BRIEF DESCRIPTION OF THE DRAWINGS

For the purpose of illustrating the invention, the attached drawings show several embodiments that are exemplary or presently preferred. However, it should be understood that the invention is not limited to the precise arrangement and instrumentality shown in the accompanying drawings.

FIG. 1A: is a bottom view of an exemplary embodiment of a motor controller to be worn on a user's hand;

FIG. 1B: is a bottom view of another exemplary embodiment of a motor controller to be worn on a user's hand with part of the glove cutaway;

FIG. 2: is an illustration of a side view of a swim spa showing implementation and usage of a preferred embodiment of the remote motor controller;

FIG. 3: is a flowchart of the system elements for a preferred embodiment of the remote motor controller;

FIG. 4: is a schematic illustration of a preferred embodiment of a computer processor and associated memory in connection with the motor controller and motor;

FIG. 5: is a flowchart of the system elements for a preferred embodiment of the remote motor controller including a computer processor and memory to store and recall a time history of the motor speed;

FIG. 6A: is a bottom view of an exemplary embodiment of a motor controller to be worn on a user's hand including a stop watch feature;

FIG. 6B: is a top view of an exemplary embodiment of a motor controller to be worn on a user's hand including a stop watch feature;

FIG. 7: is a front view of a preferred embodiment of heads-up display mirror used in a swim spa setting; and

FIG. 8: is a view through a set of swim goggles of a preferred embodiment of an eyes-up display for use with swim goggles.

### DETAILED DESCRIPTION OF PREFERRED EMBODIMENTS

The present invention is a hand worn device and associated system to allow a user to remotely control the speed of an electric motor using wireless technology, such as radio frequency or infrared signals. A key element of the device and system is worn on the user's hand and is designed to provide an intuitive means for the user to increase or decrease the speed of the motor, or to stop the motor completely. In certain preferred embodiments, the inventive device and system may be used by an athlete to control the speed of a treadmill (for a walker or runner), or the current speed of a swim spa (for a swimmer). Another element of the system, in an enhanced embodiment, is a computer processor with associated memory to record one or more time histories of the speed of the exercise equipment motor. As recorded, the motor speed time histories may be later recalled and “replayed” to control the equipment motor speed thereby allowing the athlete or user to repeat the exercise exertion level previously recorded.

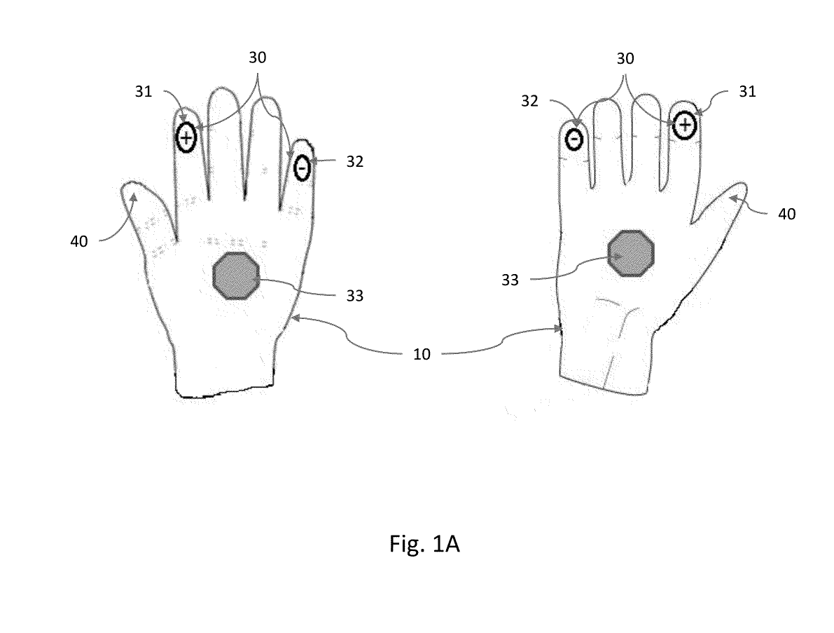

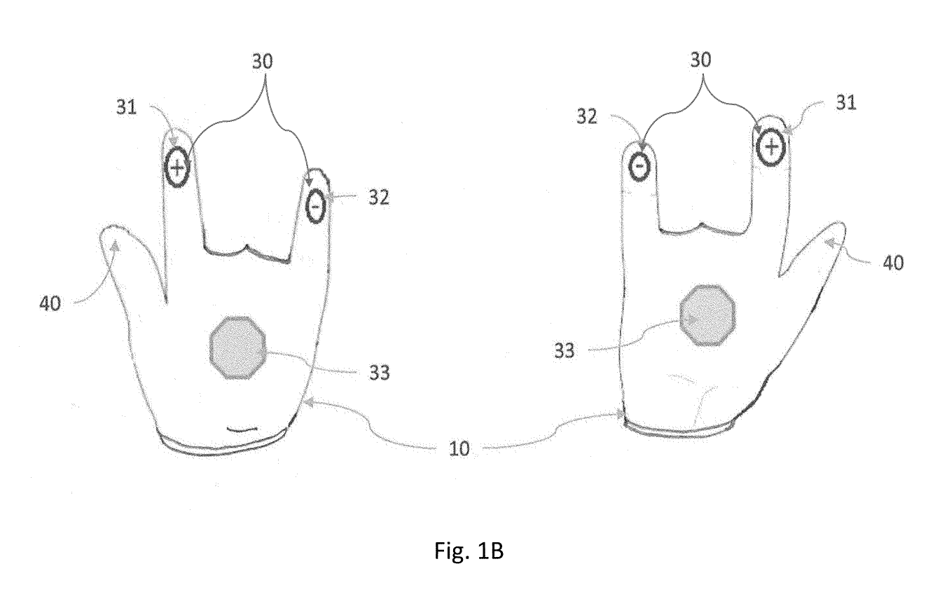

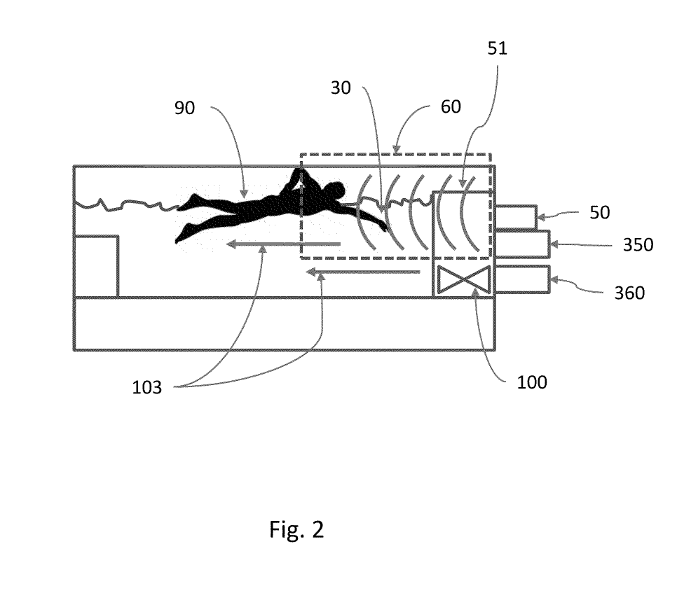

In an exemplary embodiment, as illustrated in FIGS. 1A, 1B, and 2, the control device 10 may be a glove or partial glove to be worn on the user's hand. The control device 10 may be, as shown, configured to be a glove that may be worn on a user's left or right hand. In terms of operation, in one preferred embodiment, the glove has incorporated into the glove material, in particular locations, a plurality of radio frequency identification (“RFID”) passive tags 30 that are intermittently or continuously polled by a remote RFID receiver or reader 50. The RIFD receiver or reader 50 should be located within close proximity of the user or athlete 90 and the glove 10. Because the environment in which the glove 10 is intended to be used may be in or near water, or in a sweat prevalent area, it is desired that the glove 10 not have any electrical power source, including any battery, incorporated into the glove 10. Such power sources, or electricity connected to the glove 10 could cause an undesired electrical pulse or charge being felt by the user 90.

While various wireless technology signals, other than radio frequency (“RF”) or RFID, could be used for the inventive control system, several of these signal technologies require a power source to operate. For example, while infrared (“IR”) signals could also be used to provide control signals from the glove 10 to a receiving unit 50, such signals generally require a power source. Moreover, IR transmissions typically require an approximately clear line-of-sight between the transmitting and receiving elements to be fully effective. By contrast RF or RFID signals, and in particular low frequency (“LF”), high frequency (“HF”), and ultra-high frequency (“UHF”) passive RFID tags do not need or have electrical power sources, and are not limited to having a clear line-of-sight between the sending and receiving units. Such RFID devices are accordingly more likely to be useful for certain of the exemplary embodiments.

Still further alternative technology, being Near Field Communication or “NFC” offers another variant of wireless technology (similar to RFID) that is currently being incorporated for use with smartphones. While NFC wireless technology may be, in the future, useful for wireless remote motor control, current NFC technology is likely not acceptable with respect to proximity limitations. More particularly, NFC require a very close proximity between a reader and the tag to be workable. More specifically, while the theoretical working distance for NFC tags with compact standard antennas is indicated to be up to 20 cm, the acknowledged practical working distance of such tags is more in range of 4 cm. As such NFC technology may provide an alternative communication means in the future with improved antenna technology, but is not likely to be reasonable feasible or workable for the exemplary embodiments at the time of the filing of this application.

In further operational detail, using RFID technology for an exemplary embodiment, FIG. 2 illustrates the inventive system used for a swim spa. More specifically, the proximity of the reader or receiver 50 must be close enough to the passive tags 30 such that when the reader 50 interrogates (by emitting radio waves 51) the passive tags 30, the tag or tags 30 are within the reader's range 60 to be energized, and then provide a return signal back to the reader 50. The way passive RFID tags 30 operate is that when radio waves 51 from an RFID interrogator/reader 50 reach the passive tag's antenna, the RF energy is converted into electricity to power the passive tag's microchip. The passive tag 30 can then transmit the chip's stored data back to the reader/interrogator 50. While the read range of passive RFID tags 30 depends on several factors, including the frequency of radio waves used for the tag-reader communication, the size of the tag antenna, the power of the reader, and interference from metal objects or other RF devices, it is acknowledged that certain passive tags, which have no power source, can be read by a reader or receiver 50 at up to approximately 15 to 20 feet.

Active RFID tags, as compared to passive RFID tags 30, require an installed power source, but can be read at significantly larger distances, up to, by way of example, 300 feet or more. Such active tags are often used for roadway toll collection systems. Given the desire to not have an electrical power source incorporated into the glove element 10, it is not anticipated that active RFID tags would or should be used in certain exemplary embodiments.

With respect to the frequency of operation, RFID readers and tags generally have four ranges of radio frequency for operation, being low, high, ultrahigh and microwave. Low-frequency (“LF”) tags operate between 125 kHz to 134 kHz, are less subject to interference, and are generally better suited for environments with metal or high moisture or water. However, LF tags have a read range of about one foot. High-frequency (“HF”) tags operate at between 13 to 14 MHz and have a read range of approximately 3 feet. Moreover, HF tags transmit data faster than LF tags, and are often used in smart cards.

Ultra-High Frequency (“UHF”) tags operate between 860 MHz to 960 MHz, and can transmit data faster and farther—15 to 30 feet—than either HF or LF tags. UHF tag signals may however be absorbed or dissipated in high moisture or water environments. Finally, microwave tags operate at about 5.8 GHz, have high transfer rates, and can be read from as far as 30 feet. However, such tags require substantial power sources and are costly. Accordingly, in preferred exemplary embodiments, HF to UHF RFID readers and tags should provide sufficient range to interrogate and receive a return signal as operated in the anticipated environments. Finally, those skilled in the art realize that the size of the tag antenna may impact read range, such that if the antenna is reduced in size, the read range similarly will be reduced. As such, as antenna technology evolves and improves, LF or HF RFID readers and tags may provide ample read range for the anticipated control applications.

As further shown in FIGS. 1A and 1B, the control device/glove 10 would have a plurality of intuitive control or activation points with passive RFID tags 30 embedded at some of those locations or points, to control the motor 100. More particularly, as illustrated in FIGS. 1A and 1B, a passive tag 31 would be located at the tip of the glove's 10 index finger (shown with an encircled “+” sign at the end of the index finger), and would be used to increase motor speed. Similarly, a passive tag 32 would be located at the tip of the glove's 10 little finger (shown with an encircled “−” sign at the end of the little finger), and would be used to decrease motor speed. Further, a passive tag 33 would be located in the palm area of the glove 10 (shown with a “STOP” sign on the palm area of the glove), and would be used to stop the motor.

In operation, in an exemplary embodiment, to increase the speed of the motor, the user/athlete 90 would simply touch the tip of his or her thumb 40 to the tip of his or her index finger to activate the increase speed passive tag 31. To decrease the motor speed, the user/athlete would touch the tip of his or her thumb 40 to the tip of his or her little finger to activate the decrease speed passive tag 32. Finally, to signal a motor stop, the user 90 need only touch the tip of his or her ring or middle finger against the palm section of his or her hand to activate the stop motor passive tag 33.

More specifically, the passive RFID tags 31, 32, and 33 are located in distinct areas or sections of the device or glove, such that touching the thumb and index finger activates the increase speed RFID tag 31 so that as reader 50 polls the passive tag, the tag responds and provides an ID signal to increase the motor speed. Similarly touching the thumb and little finger activates a different RFID tag (to decrease motor speed) so that as the reader 50 polls the passive tag 32, the tag responds and provides an ID signal to decrease the motor speed. In the same manner, touching the ring or middle finger of the user's hand to the palm of the glove activates a different RFID passive tag (to stop the motor) so that as the reader 50 polls the passive tag 33, the tag generates and provides an ID signal to stop the motor. While FIGS. 1A and 1B show a left and right glove 10, it is expected that the user or athlete 90 would only wear one glove 10.

In an exemplary embodiment, using the described passive RFID tags 30, the control inputs operate as follows. An RFID reader or receiver 50 is located in close proximity to the user 90. For a treadmill, the reader 50 could be near or in the front display panel. Alternatively, the reader 50 could be positioned in the front of the treadmill proximate to the motor 100. For a swim spa, as specifically illustrated in FIG. 2, the RFID reader 50 could be located near the front of the spa/pool and within 2 to 6 feet of head of the swimmer. In either of these embodiments, the location of the RFID reader 50 is such that the user's hand with the glove 10 is at some points during the exercise motion, within the range or zone 60 through which the RFID reader signals 51 are projected from the reader 50 so that the reader 50 is able to interrogate the passive tags 31, 32, and 33 during the athlete's exercise routine swimming against the current 103.

More particularly, as the athlete's hand and glove 10 enters the RFID reader read zone 60, if the user/athlete has not activated either the increase speed 31, decrease speed 32, or motor stop 33 passive tags, then the reader interrogation of the passive tags results in no signal being generated by any of the passive tags 30, and no signal is sent back to the receiver 50. Accordingly, no signal would be sent by the receiver 50 to the motor 100 or motor controller 120.

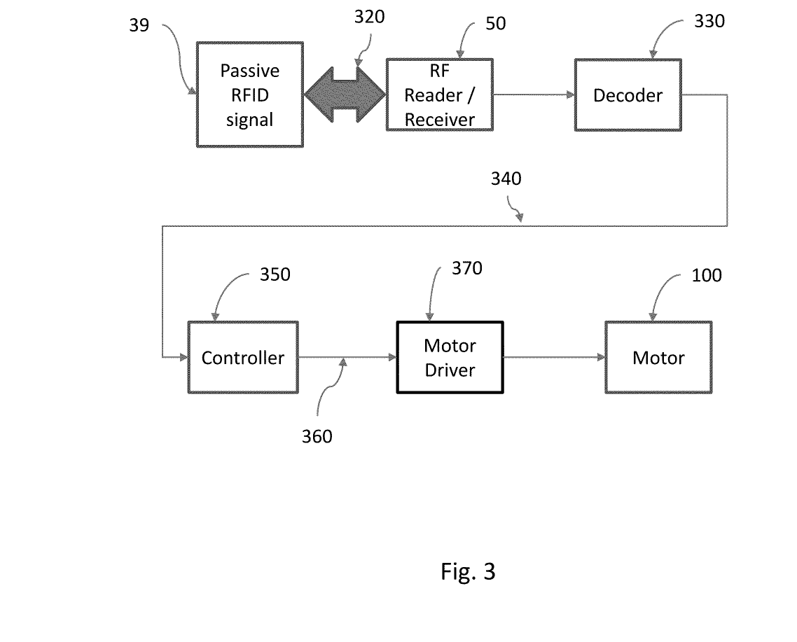

If however, the swimmer/athlete 90 has activated either the increase speed 31, decrease speed 32, or motor stop 33 tag signal, by either touching his or her thumb to his or her index finger (to increase speed), or touching his or her thumb to his or her little finger (to decrease speed), or touching his or her ring and/or middle fingers to the palm of the gloved hand (to signal a motor stop), then the reader 50 interrogation of the passive tags 30 results in the activated passive tag generating a return identification signal that is sent back to the reader 50. The RFID reader 50 accordingly receives the respective passive tag signal (increase speed, decrease speed, or motor stop), and, as shown in the FIG. 3 block diagram, transmits that respective signal in turn to a decoder 330, the motor controller 350, the motor driver 360, and finally to the motor 100 to either increase or decrease speed, or stop the motor 100.

An example of the above described controllable passive RFID tags are described in further detail in A Capacitive Touch Interface for Passive RFID Tags as presented at the 2009 IEEE International Conference on RFID, and published in the conference proceedings as pages 103 to 109, which such pages are incorporated herein by reference.

In other embodiments, as suggested above, instead of passive RFID tags 30, active RFID tags having a power source could alternatively be used in the glove 10. Similarly, other RF or IR circuits and signal generators, again with an appropriate power source in the glove, could likewise be used as an alternative to the passive tags. Finally, other wireless signal generators could be used to create the motor control signals, however, such signal generators would probably need to have a power source in the glove 10. While such systems could be manufactured, they may not be suitable for certain water immersed embodiments of the invention, because of the need for a power source within the glove 10.

Because in the above disclosed exemplary embodiment, only the thumb, index finger, little finger, and palm area of the user's hand are used for control inputs, a partial or cutaway glove 10, such as illustrated in FIG. 1B, may be used, and thereby provide the user with substantial sections of his or her hand that are open to the air or water. With such sections of the glove 10 removed, the user is able to sense the outside environment, be it air or water or a solid object (such as a touch screen), through the parts of the user's hand that are not covered by the glove 10. Other different variants of cut-away gloves can be used and are equally effective as a control device 10, including having a cut-away for the thumb of the user (not shown), and still provide the user with the ability to have direct sensation of the outside environment with the part of his or her hand that is not covered by the glove 10.

In further detail, the method and operation of the device and system, in an exemplary embodiment, is illustrated in the FIG. 3 block diagram. As shown, when the user activates one of the passive RFID tags 31, 32, and 33 incorporated into the glove 10, the respective passive tag signal 39, to either increase speed, decrease speed, or stop the motor, each as described above with reference to FIGS. 1A, 1B, and 2, is able to be activated and read by the RFID reader/receiver 50. When that passive tag 30 signal 39 is read by the reader 50, the signal is wirelessly transmitted 320 to the RF receiver 50. The respective signal is then decoded 330 after receipt by the RF receiver 50, and is then transmitted 340 to the motor controller 350. The motor controller 350 then passes 360 the respective control signal to the motor driver 370, which in turn controls the motor speed based upon the RF signal input 39. Specifically, an increase speed signal increases the motor speed; a decrease speed signal decreases the motor speed; and a stop motor signal stops the motor 100.

In one exemplary embodiment of the operation of the remote control system, so long as the user's thumb and index finger are touching, the RFID passive tag 31 is activated and an increase speed signal (transmitted to the motor controller 350) will remain, thereby instructing the controller 350 to continue to increase the speed of the motor 100. Similarly, as long as the user's thumb and little finger are touching and the RFID decrease speed passive tag 32 is activated, the signal to the motor controller 350 to decrease the motor speed will continuously decrease the motor speed.

In an alternative embodiment, providing for discrete step control, upon the user touching his or her thumb tip with his or her index finger tip, a single increase motor speed signal is generated by the passive tag 31 and sensed by the reader 50. To increase the motor speed further would require the user to release his or her thumb and index finger, and then retouch his or her thumb and index finger. Accordingly, in this manner and embodiment, the user has the ability to increase or decrease the motor speed in discrete increments. With appropriate calibration of the single signal sent from the RFID passive tags 30 as applied to the motor controller 350, the glove control device 10 can be used to increase or decrease the exercise exertion by a specific amount, for example, by 0.1 miles per hour. With differing calibration, the incremental increase or decrease could be a larger or smaller amount. Such calibration could be set when the glove 10 and motor controller 350 are manufactured, or in an alternative embodiment, the calibration, or amount of speed increase or decrease with each activation of an RFID signal could be set and varied by the end-user.

While the microchip within the passive tag typically carries a limited amount of data, usually a maximum of 2 KB of data, such amount of data is more than adequate to store basic information required about the tag, including in the exemplary embodiments, whether the RFID tag 30 is to increase motor speed, decrease motor speed, or provide for a full motor stop. Moreover, some RFID tags have chips with read-only capabilities, with information stored on the tag during manufacturing that cannot be revised or updated. Still other tags have chips that have read-write functionality, thereby allowing data to be modified or updated from time to time. Such latter tags and chips could be used for calibration of the discrete increase/decrease motor speed increments.

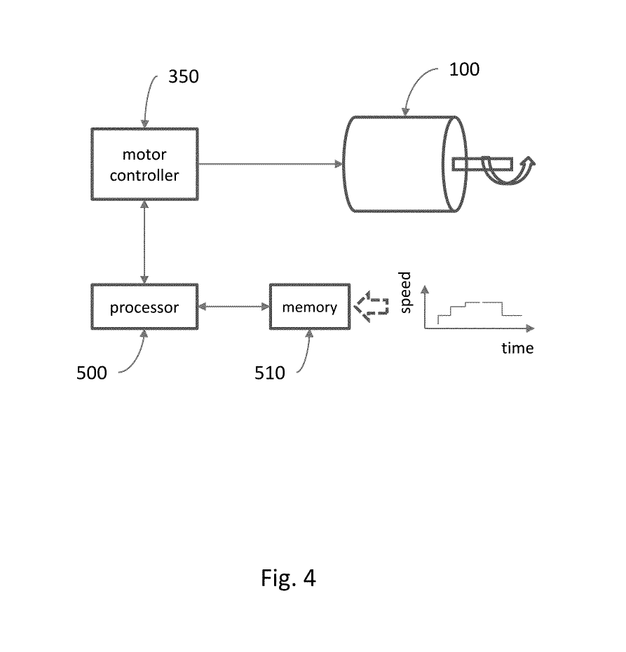

In a further exemplary embodiment of the inventive system, as shown in FIG. 4, a computer processor 500 with associated data memory 510 is communicatively connected to the motor controller 350. The computer processor 500 records and saves to the data memory 550 a time history of the motor controller signals as a function of time, illustrated in FIG. 4 next to the memory 510. In other words, the computer processor 500 records and saves a time history record of the controller speed input to the motor driver 360. The data memory 510 of the computer processor 500 can be sized to record multiple time histories of the motor speed. Where multiple time histories are stored, the computer processor 50 automatically saves each time history file under a unique file identifier. In a preferred embodiment, the user is able to recall and rename any of the recorded and saved time histories, thereby making it easier to recall any particular desired recorded motor speed time history.

By saving or recording a time history of the motor speed control, the user can later recall the recorded time history, and select to drive the motor using the recorded time history. This allows the athlete/user 90 to repeat the same exertion level as a function of time, and thereby monitor his or her performance at different times, or on different days.

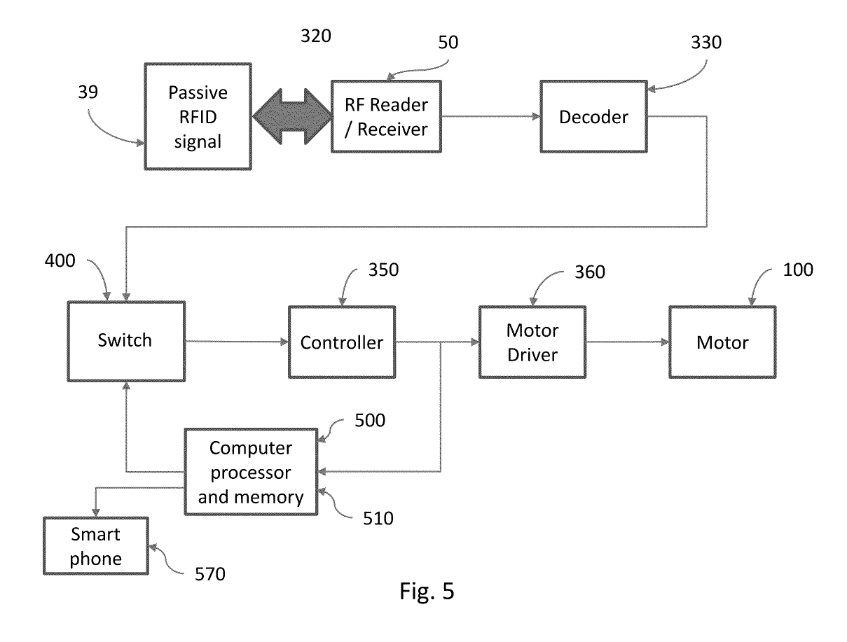

As shown in the FIG. 5 block diagram, for the embodiment allowing the motor to be controlled by a recorded and saved time history, a switch 400 is implemented to take input from either the RF decoder 330 or the output from the computer processor 500 depending upon whether the user 90 desires to directly control the motor speed, or have a prior recorded time history control the motor speed. Based upon the user's decision, the switch 400 is either set to transmit direct control input from the user 90 (through the RF reader 50 and decoder 330), or to transmit the previously recorded time history to the motor controller 350 from the computer processor 500. In this fashion, as described above, the user or athlete 90 can “replay” a previously recorded motor speed profile to repeat exercise against, and thereby monitor his or her fitness level at different times.

In a further exemplary embodiment, as illustrated in FIG. 5, the recorded time history could be transmitted by the computer processor 500 to a remote electronic device 570, such as a smartphone that can undertake various analytics, such as comparison to prior exercise routines, or simply provide information that can be transmitted through social media.

By way of example, the above described embodiment having a computer processor 500 and associated memory 510, could be used for physical rehabilitation to allow the user and/or physical therapist to monitor and measure improvement or degradation of rehabilitation or an injury based upon the patient's repeat of a recorded exertion time history. Alternatively, the described embodiment could be used by swim instructors or swim teams, such as swim clubs, colleges, or Olympic training facilities, to monitor an athlete's training as a function of time.

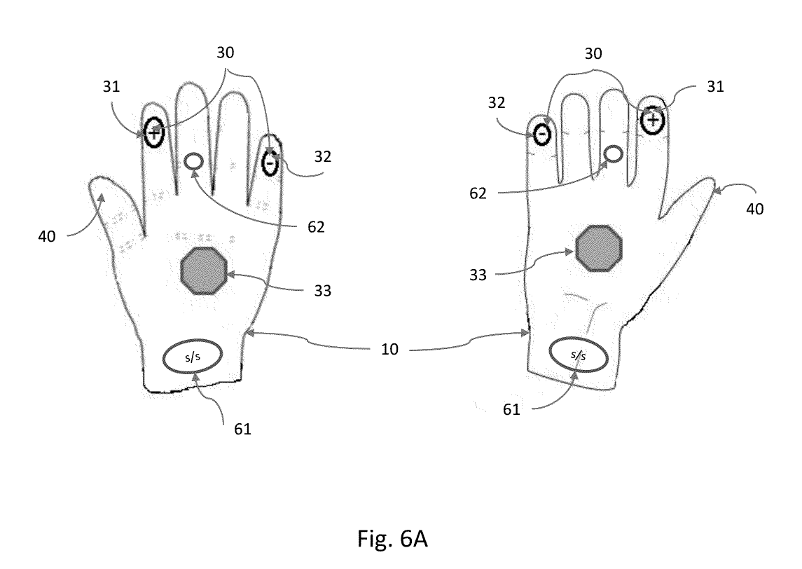

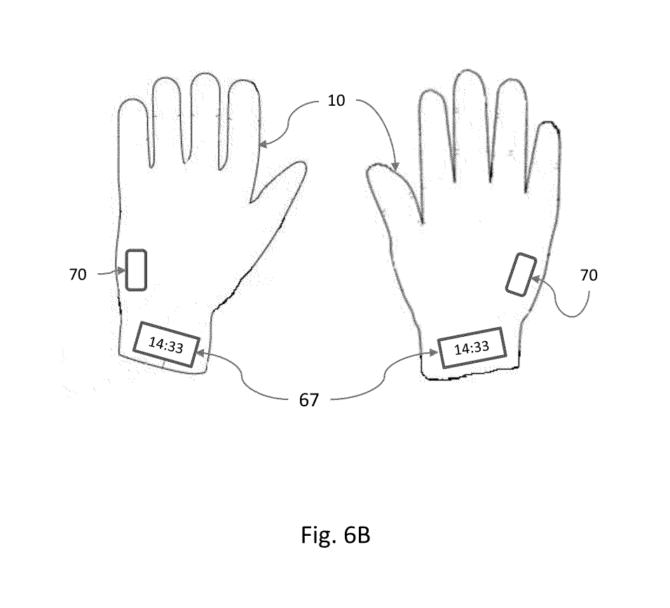

In a further enhancement and preferred embodiment to the inventive system, the glove device 10 could also comprise a stopwatch activated by touching a start/stop (shown with a “s/s” label) location 61 on the glove 10, as shown in FIG. 6A, being near the wrist of the user's glove 10 so as not to be confused with the motor increase or decrease signals at the finger tips. The stopwatch would allow the user to record the duration or length of time of the exercise. A lap function 62 could also be included on the glove 10, as shown in FIG. 6A, to allow the athlete to record the time for particular laps or segments of the exercise. The lap activation tag 62 is shown in an exemplary embodiment near the middle section of the user's middle finger to ensure it is not inadvertently activated or confused with the increase or decrease motor speed tags. Other locations for the lap tag could be used on the glove 10. The stopwatch output would be readable by the athlete 90, or displayed to the athlete, from a separate device, as described below. In an alternative embodiment, the stopwatch readout could be included as a digital readout 67, as shown in FIG. 6B, located on the back section of the glove 10 near the wrist area of the glove.

Additional features that may be included with the glove control system are a swim stroke counter, and/or a heartrate monitor. The stroke counter would work through at least one accelerometer 70 embedded in the glove 10. The accelerometer 70 in the glove 10 senses the rotation of the swimmer's arm and hand as the swimmer lifts his or her arm over his head to start the swim stroke and then pulls his or her arm back through the water to the starting position. The accelerometer/stroke count data can be transmitted to the computer processor 500, for later read out, or can be displayed to the swimmer through various means as described below. Such display means could also be a digital readout located in the wrist region of the glove, or on the back of the glove, similar to the stopwatch display, as illustrated in FIG. 6B.

The swimmer's heartrate could also be sensed by measuring the blood flow and a pulse from the wearer's thumb or wrist area. In alternative embodiments, the swimmer's heart rate can be determined by sensing blood flow and pulse from one or more of the wearer's fingers, using, in one embodiment, optical sensors. Similar to the swim stroke data, the heartrate data can be transmitted to the computer processor 500 for recording and later readout. Alternatively, the heartrate data can be displayed directly to the swimmer through various display means such as, similar to as described above, a digital readout located in the wrist region of the glove 10, or on the back of the glove. With the potential for multiple data readouts, such as elapsed time, swim stroke, and/or heartrate, in an exemplary embodiment, a single display 67 could be incorporated in the glove 10, such as shown in FIG. 6B, and the data to be displayed could be cycled through as a function of time. In such an embodiment, the display for each data output could be shown for approximately 2 to 3 seconds, before the next data output is shown. The athlete 90 could then see the respective data output for elapsed time, swim stroke, and/or heartrate by viewing the same display on the back of the glove 10.

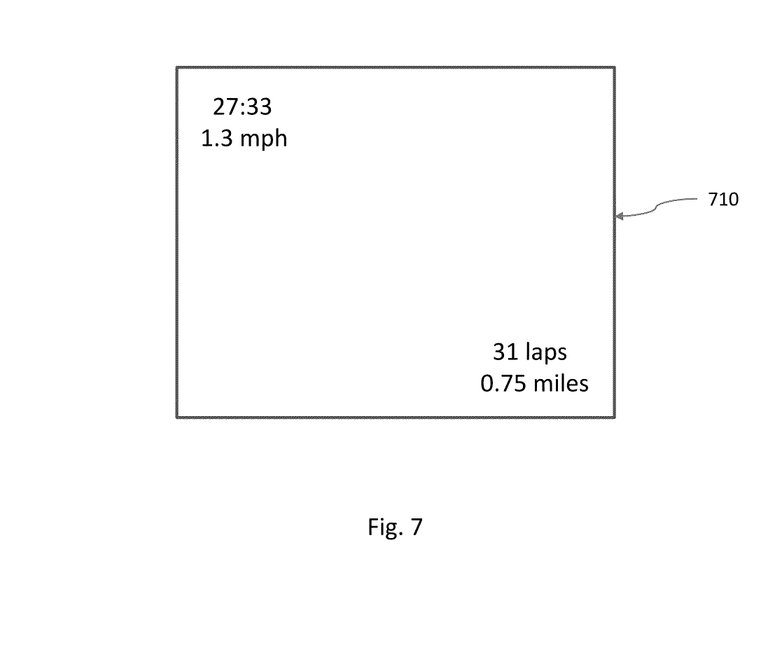

In still a further enhancement and providing an additional element and feature to the glove control system where used in a swim spa setting, the data measured at the glove, along with separately measured data, such as current speed, can be displayed on a mirror 710 positioned at the front of the pool, such that it can be easily observed and read by the swimmer 90 during the swim exercise. In an exemplary embodiment of the mirror display, FIG. 7 shows how the data can be shown without impairing the swimmer's view of his or her image in the mirror 710. The mirror 710 essentially becomes the equivalent of a heads-up display allowing the swimmer 90 to monitor various sensed data, in real-time, including without limitation, current/swim speed, duration of exercise, total distance or laps completed, average stroke rate per lap, average stroke rate per minute, total strokes, and heartrate where such data is being monitored or sensed.

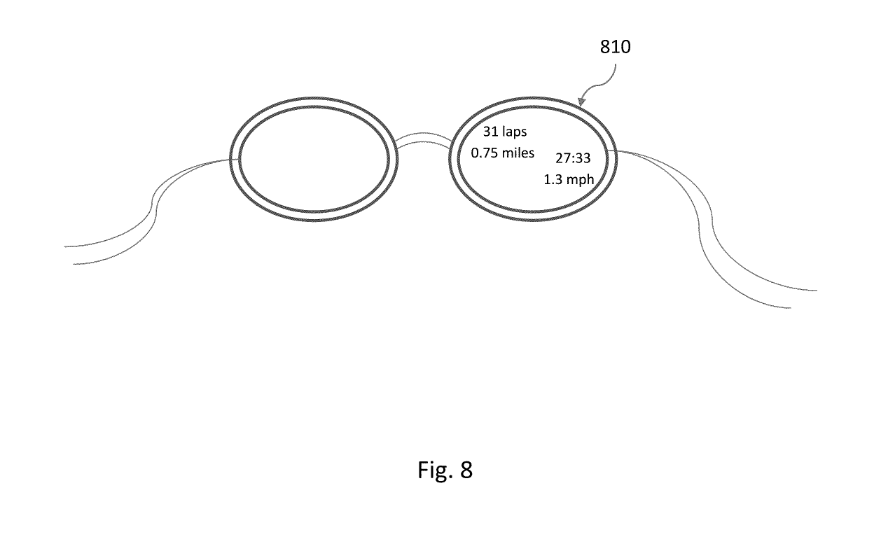

In still a further preferred embodiment, the information transmitted to the mirror 710, as described above, could also or alternatively be displayed on the swimmer's goggles 810 as a heads-up-display (“HUD”). An exemplary illustration of such display in a pair of swimmer's goggles is shown in FIG. 8. Wireless methods and systems for displaying information on swimmer's goggles have been described in U.S. Pat. No. 4,796,987 for a Digital Display For Head Mounted Protection, and U.S. Pat. No. 7,185,983 for a System and Method For Displaying Information On Athletic Eyewear which are both incorporated by reference herein.

While various preferred embodiments have been disclosed herein showing use of a glove to remotely control a swim spa current motor, in another preferred embodiments, the remote control device could be used to control other types of motors, including for example, for treadmills, a crane or other types of lift or movement motors. As disclosed, while the various exemplary embodiments show use of passive RFID technology and signals to control the motor, in other embodiments of the inventive system and method, other wireless technologies could be used, such as active RFID, RF, IR, NFC, or other wireless signals.

The above detailed description teaches certain preferred embodiments for the present inventive remote control device, system and method to control motor speed. While preferred embodiments have been described and disclosed, it will be recognized by those skilled in the art that modifications and/or substitutions are possible and such modifications and substitutions are within the true scope and spirit of the present invention. It is likewise understood that the attached claims are intended to cover all such modifications and/or substitutions.

What is claimed is:

1. A device to remotely control a motor, using radio frequency signals, comprising:
an apparatus worn on a user's hand;
a radio frequency transmitter incorporated into said apparatus;
a radio frequency receiver within communication proximity to said radio frequency transmitter;
a motor communicatively connected to said radio frequency receiver;
wherein said user may remotely control the speed of said motor by activating said radio frequency transmitter incorporated into said apparatus, whereby upon activation by the user, a radio frequency signal is read from the radio frequency transmitter by said radio frequency receiver, and said signal is transmitted to said motor to control said motor speed.

2. The device to remotely control a motor of claim 1, wherein said radio frequency transmitter is at least one passive RFID tag.

3. The device to remotely control a motor of claim 1, wherein the user is an athlete.

4. The device to remotely control a motor of claim 2, further comprising a stop watch for the athlete to record duration of exercise.

5. The device to remotely control a motor of claim 1, wherein the user is a swimmer in a swim spa.

6. The device to remotely control a motor of claim 5, further comprising in said apparatus worn by the swimmer, an automatic swim stroke counter.

7. The device to remotely control a motor of claim 2, further comprising a heartrate monitor.

8. The device to remotely control a motor of claim 1, wherein the apparatus worn on the user's hand is a glove.

9. The device to remotely control a motor of claim 8, wherein an increase speed control is achieved by touching the user's thumb and index finger together, and a decrease speed control is achieved by touching the user's thumb and little finger together.

10. The device to remotely control a motor of claim 8, wherein said motor is stopped by touching the user's palm area of the apparatus.

11. The device to remotely control a motor of claim 8, wherein said touching of the user's thumb and index finger together creates a continuous signal to increase motor speed, and the touching of the user's thumb and little finger together creates a continuous signal to decrease motor speed.

12. The device to remotely control a motor of claim 8, wherein said touching of the user's thumb and index finger together creates a single discrete signal to increase motor speed by an increment, and the touching of the user's thumb and little finger together creates a single discrete signal to decrease motor speed by an increment.

13. A system to remotely control and record the speed of a current motor used in a swim spa, using radio frequency signals, comprising:
an apparatus worn on a swimmer's hand;
at least one radio frequency transmitter incorporated into said apparatus;
a radio frequency receiver in communication with said radio frequency transmitter;
a computer processor with data memory storage;
a motor communicatively connected to said radio frequency receiver and to said computer processor;
wherein said user may remotely control the speed of said motor by activating said at least one radio frequency transmitter incorporated into said apparatus, whereby upon activation by the user, a radio frequency signal is read by said radio frequency receiver to control said motor speed; and
further wherein said motor speed control signals are recorded as a function of time by said computer processor and stored in said data memory, such that the recorded motor speed control may be used, at a later time, to control said motor speed by the recorded motor speed.

14. The system to remotely control and record the speed of a current motor used in a swim spa, of claim 13, wherein said at least one radio frequency transmitter are a plurality of RFID passive tags.

15. The system to remotely control and record the speed of a current motor used in a swim spa, of claim 13, further comprising a separate display device viewable by said swimmer while swimming, and displaying at least one of current speed, elapsed time, total distance swam, laps swam, current heartrate, average stroke rate, and time of day.

16. The system to remotely control and record the speed of a current motor used in a swim spa, of claim 15, wherein said display device is a mirror placed near the front of the swim spa.

17. The system to remotely control and record the speed of a current motor used in a swim spa, of claim 15, wherein said display device is a set of goggles worn by the swimmer.

18. The system to remotely control and record the speed of a current motor used in a swim spa, of claim 13, wherein said computer processor and data memory can record and store multiple time histories of the motor speed.

19. The system to remotely control and record the speed of a current motor used in a swim spa, of claim 13, wherein said computer processor can upload said recorded motor speed time history to a remote wireless device.

20. A method for remotely controlling the speed of a current motor used in a swim spa, comprising the steps of:
(a) sensing whether an RF signal to increase or decrease motor speed is being transmitted remotely by a swimmer in said swim spa;
(b) increasing said motor speed if an increase signal is received;
(c) decreasing said motor speed if a decrease signal is received;
(d) stopping said current motor if a stop motor signal is received;
(e) recording said motor speed control signals as a function of time;
(f) storing in a computer memory the recorded motor speed control signals as a function of time; and
(g) thereafter being able to control the swim current motor speed by recalling said recorded and stored motor speed control signals and controlling the current motor at a later time by replaying the recorded motor speed control signals.
